(19) United States
(12) Patent Application Publication
(10) Pub. No.: US 2013/0019148 A1
(43) Pub. Date: Jan. 17, 2013

(54) APPARATUS AND METHOD FOR UPDATING ONLINE DOCUMENT

(71) Applicants: Soo Jeon LEE, Daejeon (KR); Byoung Sun LEE, Daejeon (KR); In Jun KIM, Daejeon (KR); Won Chan JUNG, Daejeon (KR); Yoo La HWANG, Daejeon (KR); Jae Hoon KIM, Daejeon (KR)

(72) Inventors: Soo Jeon LEE, Daejeon (KR); Byoung Sun LEE, Daejeon (KR); In Jun KIM, Daejeon (KR); Won Chan JUNG, Daejeon (KR); Yoo La HWANG, Daejeon (KR); Jae Hoon KIM, Daejeon (KR)

(73) Assignees: Korea Aerospace Research Institute, Daejeon (KR); Electronics and Telecommunications Research Institute, Daejeon (KR)

(21) Appl. No.: 13/440,794

(22) Filed: Apr. 5, 2012

(30) Foreign Application Priority Data
Jul. 14, 2011 (KR) 10-2011-0069950
Nov. 7, 2011 (KR) 10-2011-0115369

(51) Int. Cl. G06F 17/20

(52) U.S. Cl. 715/202

(57) ABSTRACT

Provided are an apparatus and a method that differently sets the access authority of a user for individual parts of an online document. For every parts of the online document, the user authority is set and the parts are edited only by a user that can access the part. Finally, the parts of the documents are combined as the final document. According to the present invention, the document is divided into parts and the access authority of the user is variously set, which results in maximizing the efficiency of editing the document. The editors of the individual parts inherit the authorities to other people, so that it is very efficient for the cooperative job of a document in the organization having a hierarchy.

### CROSS-REFERENCE TO RELATED APPLICATIONS

This application claims priority to and the benefit of Korean Patent Application No. 10-2011-0069950 and 10-2011-0115369 filed in the Korean Intellectual Property Office on Jul. 14, 2011, and Nov. 7, 2011, the entire contents of which are incorporated herein by reference.

### TECHNICAL FIELD

The present invention relates to an apparatus and a method for updating online documents, and more specifically, to an apparatus and a method for collaboratively editing and updating online documents.

### BACKGROUND ART

Most users use an office program for documentation. An example of the office program includes MS-Office by Microsoft. The usage method of the office program is as follows. First, a user installs an office program in a PC. Next, the user creates a document on the PC. Thereafter, the user stores a finally generated document in the PC. However, when the office program is used, there are following problems. First, when plural users share a single document, the users individually perform documentation job using a common document template and then collect the individual documents. In this case, overhead may occur in combining the documents. Second, it is difficult to manage one version of the document.

Recently, the usage of a web document creating program that operates on a web browser is increased. An example of the web document creating program is Google docs. The Google docs web program is one of the cloud computing applications and provides an office function that operates on the web browser. The web document creating program has an advantage of easily sharing documents. Further, the web document creating program has another advantage in that even though a separate document creating program is not installed in the PC, once a user accesses the web, the user can do documentation job, create a presentation material, and manage a spreadsheet. However, the web document creating program has a problem that an access authority of a single user for the single document is applied to the whole document. That is, the access authority is not individually assigned for different for parts of the document.

### SUMMARY OF THE INVENTION

The present invention has been made in an effort to provide an apparatus and a method that applies different access authorities of users to parts of a document and then collaboratively edit the online document to update an online document.

An exemplary embodiment of the present invention provides an online document updating apparatus, including: an access authority setting unit configured to set an access authority for fields included in an online document; a sub-document creating unit configured to create a sub-document including at least one field based on the access authority; a sub-document selecting unit configured to select a sub-document related to an accessing user among the created sub-documents; and an online document updating unit configured to combine all sub-document including an edited sub-document to create an updated online document when the selected sub-document is edited.

The apparatus may further include: an access authority transferring unit configured to transfer the access authority from a first user to a second user. The access authority transferring unit may include: a user information receiving unit configured to receive user information on the second user from the first user; a transferring target eligibility determining unit configured to determine whether the second user is eligible as a transferee based on the user information; and an access authority transfer processing unit configured to transfer the access authority to the second user if it is determined that the second user is eligible and notify the first user or the second user that the second user is not eligible if it is determined that the second user is not eligible.

The sub-document creating unit may include: an online document dividing unit configured to divide the online document in the unit of field; and a field processing unit configured to create a sub-document for every field based on the access authority or combine fields selected by users to create a sub-document.

The sub-document selecting unit may include: an access information creating unit configured to create access information on the selected sub-document; an access information distributing unit configured to distribute the access information based on a predetermined distribution standard; an access terminal authenticating unit configured to authenticate a terminal that accesses the sub-document based on the access information; and an input information based selecting unit configured to select the sub-document based on input information of the authenticated terminal.

The online document updating unit may include: an editor driving unit configured to drive an editor that edits a sub-document; an editing completion determining unit configured to determine whether edition is completed by sensing input of a user or analyzing an input of the user; a sub-document storing unit configured to store the sub-document that is completely edited when it is determined that the edition is completed; and an updated document creating unit configured to create the updated online document when it is determined that all edited sub-document are completely edited. When the determination is performed based on sensing, if there is no input during a predetermined period of time, the editing completion determining unit may determine that the edition is completed, and when the determination is performed based on the analysis of the user's input, if the input indicates completion of editing, the editing completion determining unit may determine that the edition is completed.

The access authority setting unit may set different access authorities for the individual fields or sets different access authorities for the users who access the same field.

The online document updating unit may include: a plural editing determining unit configured to determine whether the same sub-document is edited by at least two users; and a priority based document selecting unit configured to select a sub-document edited by a specific user based on the priority if it is determined that the sub-document is edited by at least two users.

The online document updating apparatus may be used to control a satellite by collectively editing the online document related to a satellite operation.

The sub-document creating unit may create the sub-document in response to the request of the second user that receives the access authority.

Another exemplary embodiment of the present invention provides an online document updating apparatus, including: a sub-document creating unit configured to create a sub-document including at least one field based on fields included in an online document; an access authority setting unit configured to set an access authority for the sub-document; a sub-document selecting unit configured to select a sub-document related to an accessing user among the created sub-documents; and an online document updating unit configured to combine all sub-document including an edited sub-document to create an updated online document when the selected sub-document is edited.

Yet another exemplary embodiment of the present invention provides an online document updating method, including: an access authority setting step of setting an access authority for fields included in an online document; a sub-document creating step of creating a sub-document including at least one field based on the access authority; a sub-document selecting step of selecting a sub-document related to an accessing user among the created sub-documents; and an online document updating step of combining all sub-document including an edited sub-document to create an updated online document when the selected sub-document is edited.

The method may further include: an access authority transferring step of transferring the access authority from a first user to a second user. The access authority transferring step may include: a user information receiving step of receiving user information on the second user from the first user; a transferring target eligibility determining step of determining whether the second user is eligible as a transferee based on the user information; and an access authority transfer processing step of transferring the access authority to the second user if it is determined that the second user is eligible and notify the first user or the second user that the second user is not eligible if it is determined that the second user is not eligible.

The sub-document creating step may include: an online document dividing step of dividing the online document in the unit of field; and a field processing step of creating a sub-document for every field based on the access authority or combining fields selected by users to create a sub-document.

The sub-document selecting step may include: an access information creating step of creating access information on the selected sub-document; an access information distributing step of distributing the access information based on a predetermined distribution standard; an access terminal authenticating step of authenticating a terminal that accesses the sub-document based on the access information; and an input information based selecting step of selecting the sub-document based on input information of the authenticated terminal.

The online document updating step may include: an editor driving step of driving an editor that edits a sub-document; an editing completion determining step of determining whether edition is completed by sensing input of a user or analyzing an input of the user; a sub-document storing step of storing the sub-document that is completely edited when it is determined that the edition is completed; and an updated document creating step of creating the updated online document when it is determined that all edited sub-document are completely edited. When the determination is performed based on sensing, if there is no input during a predetermined period of time, the editing completion determining step determines that the edition is completed, and when the determination is performed based on the analysis of the user's input, if the input indicates completion of editing, the editing completion determining step determines that the edition is completed.

The access authority setting step may set different access authorities for the individual fields or sets different access authorities for the users who access the same field.

The online document updating step may include: a plural editing determining step of determining whether the same sub-document is edited by at least two users; and a priority based document selecting step of selecting a sub-document edited by a specific user based on the priority if it is determined that the sub-document is edited by at least two users.

The online document updating method may be used to control a satellite by collaboratively editing the online document related to a satellite operation.

The sub-document creating step may create the sub-document in response to the request of the second user that receives the access authority.

Another exemplary embodiment of the present invention provides an online document updating method, including: a sub-document creating step of creating a sub-document including at least one field based on fields included in an online document; an access authority setting step of setting an access authority for the sub-document; a sub-document selecting step of selecting a sub-document related to an accessing user among the created sub-documents; and an online document updating step of combining all sub-document including an edited sub-document to create an updated online document when the selected sub-document is edited.

According to exemplary embodiments of the present invention, the following advantages may be achieved. First, since the different access authorities per user are assigned for parts of an online document, it is possible to efficiently perform a joint documentation and improve a security level for the online document. Second, since the online document is collaboratively edited and updated, the document can be collected without causing overhead and the document version does not need to be separately managed.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a block diagram schematically showing an online document updating apparatus according to an exemplary embodiment of the present invention.

FIG. 2A and FIG. 2B is a detailed block diagram showing a configuration that is added to the online document updating apparatus shown in FIG. 1.

FIG. 3A, FIG. 3B, FIG. 4A and FIG. 4B are block diagrams specifically showing a configuration of the online document updating apparatus shown in FIG. 1.

FIG. 5 is an exemplary color diagram when plural users cooperatively carry out a documentation job using one document.

FIG. 6 shows an exemplary diagram showing a dividing process and a combining process of a document file when an online document is updated.

FIG. 7 is a flowchart showing a process of updating an online document.

FIG. 8 is an exemplary diagram of an authority inheritance.

FIG. 9 is a block diagram schematically showing an online document updating method according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, exemplary embodiments of the present invention will be described in detail with reference to the accompanying drawings. First of all, we should note that in giving reference numerals to elements of each drawing, like reference numerals refer to like elements even though like elements are shown in different drawings. In describing the present invention, well-known functions or constructions will not be described in detail since they may unnecessarily obscure the understanding of the present invention. It should be understood that although exemplary embodiment of the present invention are described hereafter, the spirit of the present invention is not limited thereto and may be changed and modified in various ways by those skilled in the art.

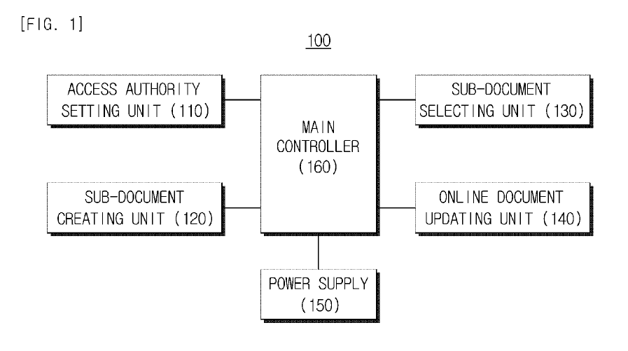

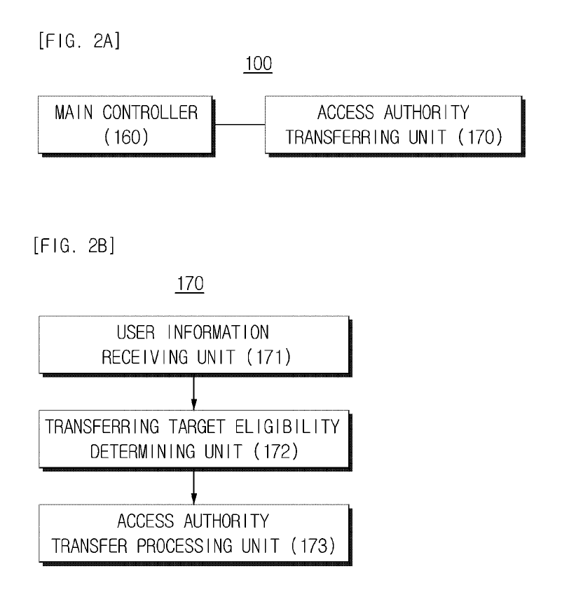

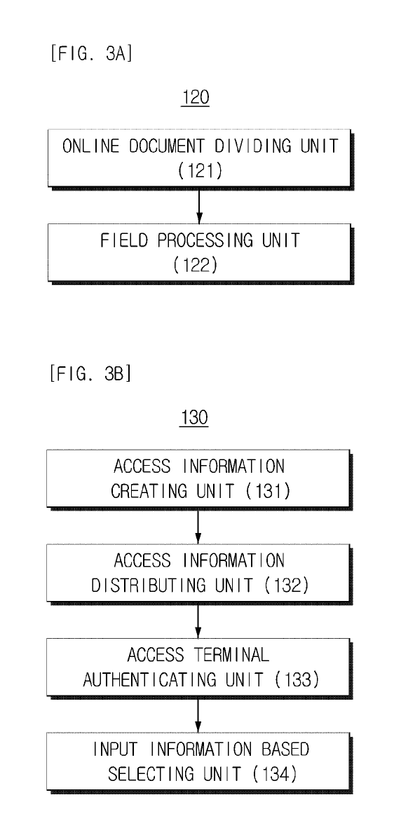

FIG. 1 is a block diagram schematically showing an online document updating apparatus according to an exemplary embodiment of the present invention. FIG. 2A and FIG. 2B is a detailed block diagram showing a configuration that is added to the online document updating apparatus shown in FIG. 1. FIG. 3A, FIG. 3B, FIG. 4A and FIG. 4B are block diagrams specifically showing a configuration of the online document updating apparatus shown in FIG. 1. Hereinafter, the exemplary embodiments of the present invention will be described with reference to FIGS. 1 to 4B.

Referring to FIG. 1, an online document updating apparatus 100 includes an access authority setting unit 110, a sub-document creating unit 120, a sub-document selecting unit 130, an online document updating unit 140, a power supply 150, and a main controller 160.

The online document updating apparatus 100 partially shares the online document such that an online document file is divided into plural sections to generate sub-files for the sections and selects a sub file that is accessible according to a user ID to assign a different access authority of a user thereto. The online document updating apparatus 100 also provides an authority inheritance for the access authority. The online document updating apparatus 100 cooperatively edits an online document for a satellite operation to be used to control a satellite. In this exemplary embodiment, the online document includes a web document.

The access authority setting unit 110 is configured to set an access authority for fields included in the online document. The access authority setting unit 110 sets different access authorities for the individual fields or sets different access authorities for the users who access the same field. When the access authority is differently set for the fields, a user A can read and write in a field A, but can only read in a field B. In contrast, when the access authority is differently set for the users who access the same field, a user B can read and write in a field C, but a user C can only read in the field C.

The sub-document creating unit 120 is configured to create a sub-document including at least one field based on the access authority. The sub-document creating unit 120, as shown in FIG. 3A, may include an online document dividing unit 121 and a field processing unit 122. FIG. 3A shows an inside configuration of the sub-document creating unit 120. The online document dividing unit 121 is configured to divide the online document in the unit of a field. The field processing unit 122 is configured to create a sub-document for every field based on the access authority or combine fields selected by users to create a sub-document. In the meantime, the field processing unit 122 may create the sub-document in response to the request of a user. When considering the above, the sub-document creating unit 120 may create the sub-document in response to the request of a second user who receives the access authority.

The sub-document selecting unit 130 is configured to select a sub-document related with an accessing user among the created sub-documents. The sub-document selecting unit 130, as shown in FIG. 3B, may include an access information creating unit 131, an access information distributing unit 132, an access terminal authenticating unit 133, and an input information based selecting unit 134. The access information creating unit 131 is configured to create access information on the selected sub-document. The access information distributing unit 132 is configured to distribute the access information based on a predetermined distribution standard. The access information distributing unit 132 may distribute the access information to a user who is previously determined according to the distribution standard or to unspecified users. The access terminal authenticating unit 133 is configured to authenticate a terminal that accesses the sub-document based on the access information. The input information based selecting unit 134 is configured to select the sub-document based on input information of the authenticated terminal.

When a selected sub-document is edited, the online document updating unit 140 is configured to combine all sub-documents including the edited sub-document to create an updated online document. The online document updating unit 140, as shown in FIG. 4A, may include an editor driving unit 141, an editing completion determining unit 142, a sub-document storing unit 143, and an updated document creating unit 144. FIG. 4A is a block diagram specifically showing an inside configuration of the online document updating unit 140. The editor driving unit 141 is configured to drive an editor that edits a sub-document. The editing completion determining unit 142 is configured to determine whether edition is completed by sensing input of a user or analyzing an input of the user. When the determination is performed based on the sensing, if there is no input during a predetermined period of time, the editing completion determining unit 142 determines that the edition is completed. When the determination is performed based on the analysis of the user's input, if the input indicates completion of editing, the editing completion determining unit 142 determines that the edition is completed. In the above-description, the predetermined period of time may be one to ten minutes. When it is determined that the edition is completed, the sub-document storing unit 143 stores the sub-document that is completely edited. If it is determined that all edited sub-documents are completely edited, the updated document creating unit 144 creates the updated online document. The editing completion determining unit 142 determines whether all edited sub-documents are completely edited.

In this embodiment, when edited documents for the same sub-document are plural, only a specific edited document is selected based on the priority. When considering this, the online document updating unit 140, as shown in FIG. 4B, may include a plural editing determining unit 145 and a priority based document selecting unit 146. FIG. 4B shows a configuration that is added to the configuration of FIG. 4A. The plural editing determining unit 145 is configured to determine whether the same sub-document is edited by at least two users. When the sub-document is edited by at least two users, the priority based document selecting unit 146 selects a sub-document that is edited by a specific user based on the priority standard. In the meantime, in this embodiment, the above functions is not limited to the sub-document, but is reflected based on a word or a sentence included in the sub-document. For example, it can be assumed that a sub-document A includes sentences A to E. When an editing document 1 edits the sentence A and an editing document 2 edits the sentence C, according to the exemplary embodiment, the editing document 1 and the editing document 2 are used to edit the sub-document.

The power supply 150 is configured to supply power to the components of the document updating apparatus 100.

The main controller 160 is configured to control the entire operation of the components of the online document updating apparatus 100.

The online document updating apparatus 100, as shown in FIG. 2A, may further include an access authority transferring unit 170. FIG. 2A schematically shows the configuration of the access authority transferring unit 170 in the online document updating apparatus 100, and FIG. 2B shows an inside configuration of the access authority transferring unit 170.

The access authority transferring unit 170 is configured to transfer the access authority from a first user to a second user. In the above description, the first user has the access authority and transfers (inherits) the access authority and the second user receives the access authority.

The access authority transferring unit 170 may include a user information receiving unit 171, a transferring target eligibility determining unit 172 and an access authority transfer processing unit 173. When the access authority is transferred, the user information receiving unit 171 receives the user information on the second user from the first user. The transferring target eligibility determining unit 172 is configured to determine whether the second user is eligible as a transferee based on the user information. If it is determined that the second user is eligible, the access authority transfer processing unit 173 transfers the access authority which is assigned to the first user to the second user. In contrast, if it is determined that the second user is not eligible, the access authority transfer processing unit 173 notifies the first user or the second user that the second user is not eligible.

The first user may transfer the entire access authority to the second user. The first user may transfer some of the access authority to the second user. The first user may divide the access authority into plural parts to transfer the access authority to at least two users. The access authority may be divided into an editing authority that edits the sub-document and a connecting authority that does not edit the sub-documents but checks contents of the sub-documents.

The configuration of the online document updating apparatus 100 described with reference to FIGS. 1 to 4 relates to a method that sets an access authority and then divides the online document into sub-documents. However, after dividing the online document into sub-documents, the access authority may be set. In this case, the components of the online document updating apparatus may be driven as follows. The sub-document creating unit creates a sub-document including at least one field based on fields included in the online document. The access authority setting unit sets an access authority for individual sub-documents. The sub-document selecting unit selects a sub-document related to an accessing user among the sub-documents to which the access authorities are set. The online document updating unit creates an online document updated by combining all sub-documents including an edited sub-document when the selected sub-document is edited. Excepting that a method of dividing the online document into the sub-documents after setting the access authority is changed into a method of setting the access authority after dividing the online document into sub-documents, the configurations shown in FIGS. 2 to 4 may be applied in this embodiment.

A document creating program that operates over a web browser has been already described. In this embodiment, a system that provides the above service is referred to as a web based documentation system.

One of the advantages of the web based documentation system is that a document can be easily shared. An owner of the document may publish a URI (uniform resource identifier) of the document. When a user access the corresponding URI through the web browser, the web based documentation system is automatically launched, so that a job for the document can be performed using the system. The document owner may set the access authority for a user for the corresponding document. For example, a user is designated to be access the document or all users can access thereto. A reading/writing authority for the document may be subdivided. In this case, a problem of a race condition occurring when plural users write different values for the same part of the document can be solved. In brief, when a collective job for a document is performed, the web based documentation system is better than the related art.

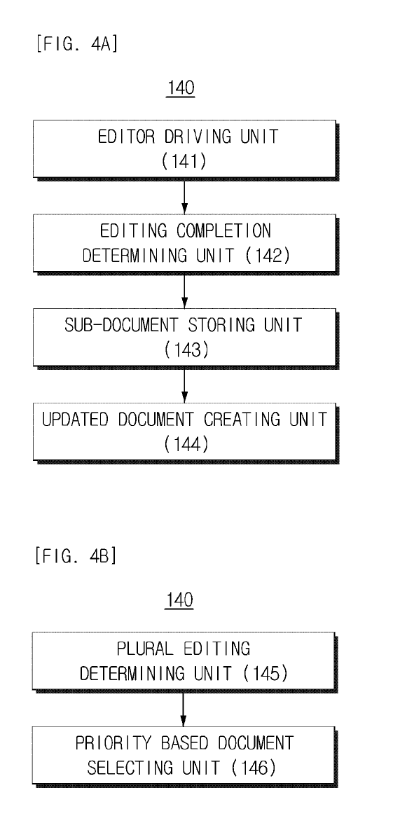

However, the web based documentation system has a limitation. For example, the access authority of a single user for the single document is applied to the whole document. In other words, the access authority is not subdivided for every part of the document. For example, a director Z instructs team leaders A, B, and C to create the team result as a shared document in a spreadsheet format. In this case, the director is an owner of the document, and the team leaders A, B, and C are users of the document. The director Z makes a document template and then notifies the team leaders of the corresponding URI. The team leaders access the corresponding URI to record the team result. In this case, each of the team leaders does not want to show their own team result to other team leaders. Therefore, even though the team leaders access the spreadsheet document template through the same URI, the team leaders need to access only their team's sheet. Hereinafter, referring to FIG. 5, the exemplary embodiment will be described. FIG. 5 is an exemplary color diagram when plural users carry out a collaborative documentation job using one document.

Team leaders B, C, and D record their team's result on a team B sheet 520, a team C sheet 530, and a team D sheet 540 according to a given format, respectively. The director A previously makes a script, which calculates a statistics for the result recorded on the team B sheet 520, the team C sheet 530, and the team D sheet 540, on a Dept A sheet 510. As a result, when input for the team results are completed, the director can obtain the statistics for the results of the entire teams only using the Dept A sheet 510. In this case, the individual team leaders only see their team's sheet, not the other team's or department's sheet.

As described above, the related art sets an access authority only for the entire document instance instructed by a specific URI. In contrast, the present embodiment sets an access authority for a corresponding instance in order to solve the above problem, which results in maximizing the efficiency of the document sharing. In the above description, even though the spread sheet is exemplified, the concept may be applied to other types of documentation applications.

When plural users access a single document through a URI link and collectively work on the documentation job for the document, an access authority of the users may be set for the shared documentation job. In the meantime, in the case of related art application, the access authority may be applied to the whole document, but different access authority of the users may be not assigned to individual parts of the document. The present embodiment suggests that access authorities for individual users are differently set for the parts of the document when the document is shared over the web browser through the URI. By doing this, a part of the document that is accessible by the user may be set and contents created by a specific user cannot be deleted or distorted by other user. Plural users may separately perform the documentation job using separate files and then the documents may be collected to be combined. However, according to the present embodiment, it is possible to resolve the inconvenience caused by combining the document and prevent erroneous combination of the document, so that plural users more efficiently perform the collective documentation job. According to the present embodiment, various scripts required to operate the artificial satellite, for example, a satellite operation procedure may be easily and collectively edited, which enables a reliable satellite control.

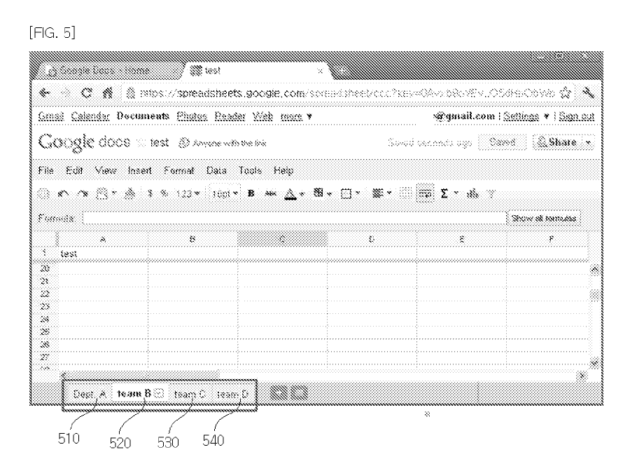

Hereinafter, in connection with a partial sharing method of a URI based online document according to the exemplary embodiment, a file dividing method for differentiating user access authorities for every part of the document will be described. According to this method, a document file is divided into parts to make plural files, which is shown in FIG. 6. FIG. 6 shows an exemplary diagram showing a dividing process and a combining process of a document file when an online document is updated.

At first, a document owner sets a user authority for individual parts of the document (640). Thereafter, an original file (version 1) 600 is divided into three parts 601 to 603 to set the access authorities for every user for the three parts. A user A has an access authority for a part 1 601 to read and write. A user B has an access authority for a part 2 602 to read and write. As for a part 3 603, both the user A and the user B are accessible, but the user A has only reading authority and the user B has reading/writing authority.

After completely setting the access authority for every user for the parts (640), the file is divided into parts (650). That is, the original file 600 is divided to create sub files 611 to 613 corresponding to the parts. For example, it is assumed that the user A accesses the document through the URI distributed by the owner of the document. In this case, the user A may read contents of the sub file 1 and the sub file 3 through a document editing program over the web browser. However, it is important that the user A does not know how many files are divided from the original document. Therefore, the sub file 1 and the sub file 3 look like a single file, not two separate files to the user A. This function is supported by the document editing program over the web browser.

When the user A and the user B complete the document editing job (660), the edited sub files 621 to 623 are combined (670) to create a combined file of a new version (version 2) (630).

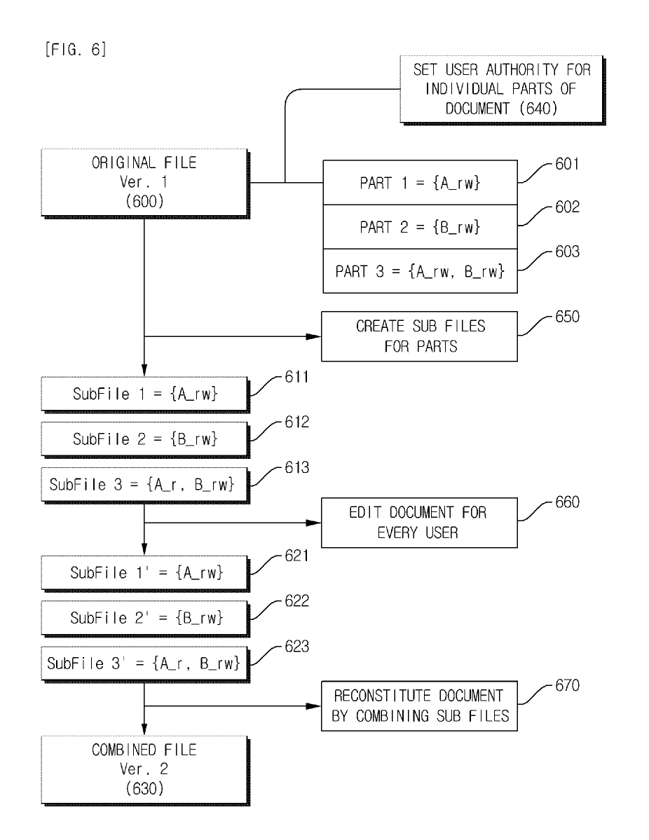

FIG. 7 is a flowchart showing a process of updating an online document. In FIG. 7, a web based documentation system 700 is a configuration related with the online document updating apparatus. Hereinafter, the description will be made with reference to FIGS. 1 to 4 and FIG. 7.

At first, a document owner 710 sets a user authority for individual parts of the document (731). This function is performed by the access authority setting unit 110. Thereafter, the document owner 710 requests to store the document and create the URI (732). Thereafter, the web based documentation system 700 divides the original file to create sub files for individual parts (733). This function is performed by the sub-document creating unit 120. Thereafter, the web based documentation system 700 creates the URI related with the sub files (734). This function is performed by the access information creating unit 131. Thereafter, the web based documentation system 700 distributes the URI (735). This function is performed by the access information distributing unit 132. Thereafter, the user 720 executes the web browser (736). Thereafter, if authentication is requested to the web based documentation system 700 through the web browser, it is determined whether the URI is accessible in response to the authentication (737). This function is performed by the access terminal authenticating unit 133. Thereafter, web based documentation system 700 selects the sub files according to a user ID (738). This function is performed by the input information based selecting unit 134. Thereafter, the web based documentation system 700 operates the editing program (739). This function is performed by the editor driving unit 141. Thereafter, the user 720 performs the document file editing job (740). Thereafter, the user 720 requests to save the edited document file (741). This function is performed by the editing completion determining unit 142. Thereafter, the web based documentation system 700 stores the edited sub files (742). This function is performed by the sub-document storing unit 143. Thereafter, the document owner 710 requests to combine the sub-document files (743). Thereafter, the web based documentation system 700 combines the sub files to create an update file for the original file (744). This function is performed by the updated document creating unit 144.

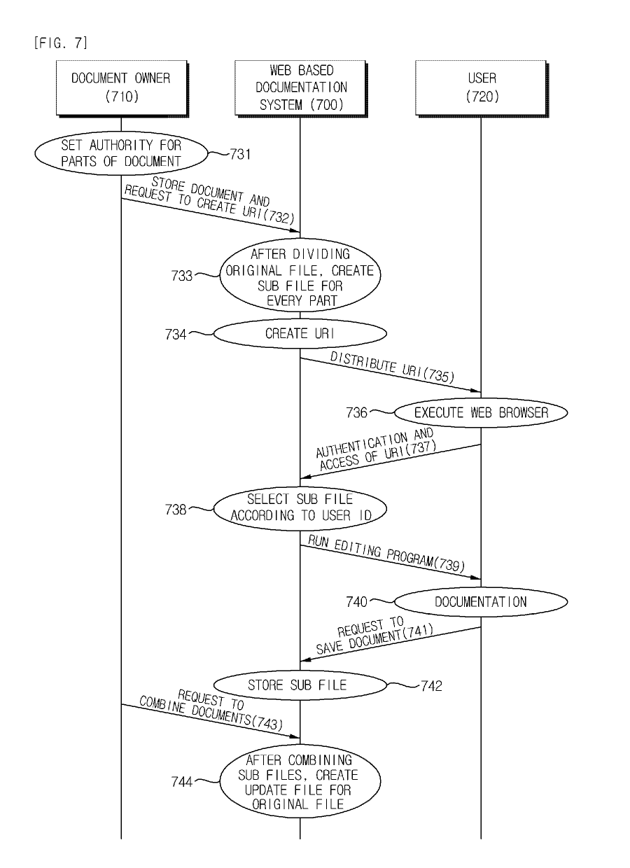

The user of the document may have a distributing authority for the part for which the user has the access authority. In this case, the user should have permission of the owner in advance. FIG. 8 is an exemplary diagram of an authority inheritance. Hereinafter, the description will be made with reference to FIG. 8.

It is assumed that an original URI of a document is http://docs.etri.re.kr/2efser34. Even though both the user A and the user B access the above URI, the user A and the user B can see different parts of the document according to their authorities. Since the user A has the access authority for the part 1 810 and the part 3 830, after completing the documentation job, the user A may distribute the URI for the part 1 810 and the part 3 830 to another user F and set the access authority. The user A may set the access authority of the user F to be the same as or lower than the access authority of the user A. The user A may divide the part 1 810 into plural parts. For example, the part 1 810 is divided into a part 1-1 840 and a part 1-2 850. Thereafter, the user A gives a reading authority to the user A for the part 1-1 840 and a reading/writing authority to a user F for the part 1-2 850 (870). If the user A allows the user F to distribute the document, the user F also gives an access authority for the part 1-3 860 that is same as or lower than the access authority of the user F to another user H (880).

The advantages of the authority inheritance are that it is easy to perform the job for the distributed document according to the hierarchy of the organization. As shown in FIG. 8, a team leader A distributes the document to team members F and G. The team member G takes a task of correcting the document. The team member F figures out the contents of the document and if it is determined that the document is useful to a team member H, the team member F distributes the document to the team member H. The function relating the authority inheritance is performed by the access authority transferring unit 170.

The exemplary embodiment relates to an apparatus and a method that plural users perform a job on a single shared document through a URI. The objective of the exemplary embodiment is to allow setting of the user authority not only for the whole document, but also parts of the document. If the user access authority can be set for parts of the document, it is possible to improve the security level and easily combine the document.

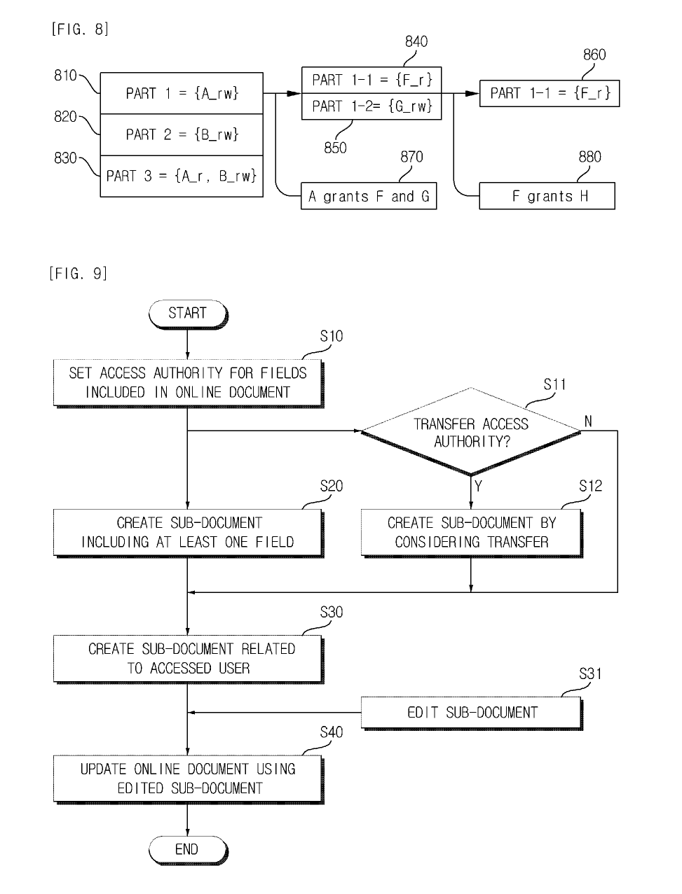

Next, an online document updating method that uses the online document updating apparatus will be described. FIG. 9 is a block diagram schematically showing an online document updating method according to an exemplary embodiment of the present invention. Hereinafter, the description will be made with reference to FIGS. 1 to 4 and FIG. 9.

First, the access authority setting unit 110 sets an access authority for fields included in an online document (access authority setting step, S10). The access authority setting unit 110 may set different access authorities for the individual fields or gives different access authorities to users who access the same field.

After the access authority setting step S10, the sub-document creating unit 120 creates a sub-document including at least one field based on the access authority (sub-document creating step, S20). The sub-document creating step S20 may include an online document dividing step and a field processing step. The online document dividing step refers to a step of dividing the online document in the unit of field. The online document dividing step is performed by the online document dividing unit 121. The field processing step refers to a step of creating sub-documents for individual fields based on the access authority or combining the selected fields according to the users to create a sub-document. The field processing step is performed by the field processing unit 122.

After the sub-document creating step S20, the sub-document selecting unit 130 selects a sub-document related to the accessing user among the created sub-documents (sub-document selecting step, S30). The sub-document selecting step S30 may include an access information creating step, an access information distributing step, an access terminal authenticating step, and an input information based selecting step. The access information creating step refers to a step of creating access information for the selected sub-document. The access information creating step is performed by the access information creating unit 131. The access information distributing step refers to a step of distributing the access information based on the predetermined distribution standard. The access information distributing step is performed by the access information distributing unit 132. The access terminal authenticating step refers to a step of authenticating a terminal that accesses the sub-document based on the access information. The access terminal authenticating step is performed by the access terminal authenticating unit 133. The input information based selecting step refers to a step of selecting a sub-document based on the input information of the authenticated terminal. The input information based selecting step is performed by the input information based selecting unit 134.

In the meantime, the sub-document may be created by the request of the user. In this case, the sub-document creating unit 120 may create a sub-document in response to the request of the second user who receives the access authority.

After the sub-document selecting step S30, when a selected sub-document is edited S31, the online document updating unit 140 combines all sub-documents including the edited sub-document to create an updated online document (online document updating step S40). The online document updating step S40 includes an editor driving step, an editing completion determining step, a sub-document storing step, and an updated document creating step. The editor driving step refers to a step of driving an editor that edits a sub-document. The editor driving step is performed by the editor driving unit 141. The editing completion determining step refers to a step of determining whether edition is completed by sensing input of a user or analyzing an input of the user. The editing completion determining step is performed by the editing completion determining unit 142. When the determination is performed based on the sensing, if there is no input during a predetermined period of time, the editing completion determining step determines that the edition is completed. When the determination is performed based on the analysis of the user's input, if the input indicates completion of editing, the editing completion determining step determines that the edition is completed. The sub-document storing step refers to a step of storing the sub-document that is completely edited when it is determined that the edition is completed. The sub-document storing step is performed by the sub-document storing unit 143. The updated document creating step refers to a step of creating the updated online document if it is determined that all edited sub-documents are completely edited. The updated document creating step is performed by the updated document creating unit 144.

However, the edited documents for the same sub-document may be plural. In this case, according to the exemplary embodiment, only a specific edited document may be selected based on the priority. In this case, the online document updating step S40 may further include a plural editing determining step and a priority based document selecting step. The above steps may be performed between the editor driving step and the editing completion determining step. The plural editing determining step refers to a step of determining whether the same sub-document is edited by at least two users. The plural editing determining step is performed by the plural editing determining unit 145. The priority based document selecting step refers to a step of selecting a sub-document that is edited by a specific user based on the priority standard when the sub-document is edited by at least two users. The priority based document selecting step is performed by the priority based document selecting unit 146.

In addition to the above-mentioned steps S10 to S40, an access authority transferring step may be further performed. In the access authority transferring step, the access authority transferring unit 170 transfers the access authority from the first user to the second user. The access authority transferring step may be performed at any time after the access authority setting step S10, but preferably performed prior to the online document updating step S40. For example, as shown in FIG. 9, the access authority transferring step S11 to S12 may be performed simultaneously with the sub-document creating step S20. The access authority transferring step may include a user information receiving step, a transferring target eligibility determining unit S11, and an access authority transfer processing unit S12. The user information receiving step refers to a step of receiving user information on the second user from the first user when the access authority is transferred. The user information receiving step is performed by the user information receiving unit 171. The transferring target eligibility determining step refers to a step of determining whether the second user is eligible as a transferee based on the user information. The transferring target eligibility determining step is performed by the transferring target eligibility determining unit 172. The access authority transfer processing step S12 refers to a step of transferring the access authority to the second user if it is determined that the second user is eligible or notifying the first user or the second user that the second user is not eligible if it is determined that the second user is not eligible. The access authority transfer processing step S12 is performed by the access authority transfer processing unit 173.

In the meantime, after dividing the online document, the access authority for the divided sub-document may be set. In this case, the online document updating method may be performed as follows: First, a sub-document including at least one field is created based on fields included in the online document (sub-document creating step). Thereafter, an access authority is set for individual sub-documents (access authority setting step). Thereafter, a sub-document related to the accessing user is selected among the sub-documents to which the access authorities are set (sun document selecting step). Thereafter, if the selected sub-document is edited, all sub-documents including the edited sub-document are combined to create an updated online document (online document updating step).

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. An online document updating apparatus, comprising:
an access authority setting unit configured to set an access authority for fields included in an online document;
a sub-document creating unit configured to create a sub-document including at least one field based on the access authority;
a sub-document selecting unit configured to select a sub-document related to an accessing user among the created sub-documents; and
an online document updating unit configured to combine all sub-document including an edited sub-document to create an updated online document when the selected sub-document is edited.

2. The apparatus of claim 1, further comprising:
an access authority transferring unit configured to transfer the access authority from a first user to a second user.

3. The apparatus of claim 2, wherein the access authority transferring unit includes:
a user information receiving unit configured to receive user information on the second user from the first user;
a transferring target eligibility determining unit configured to determine whether the second user is eligible as a transferee based on the user information; and
an access authority transfer processing unit configured to transfer the access authority to the second user if it is determined that the second user is eligible and notify the first user or the second user that the second user is not eligible if it is determined that the second user is not eligible.

4. The apparatus of claim 1, wherein the sub-document creating unit includes:
an online document dividing unit configured to divide the online document in the unit of field; and
a field processing unit configured to create a sub-document for every field based on the access authority or combine fields selected by users to create a sub-document.

5. The apparatus of claim 1, wherein the sub-document selecting unit includes:
an access information creating unit configured to create access information on the selected sub-document;
an access information distributing unit configured to distribute the access information based on a predetermined distribution standard;
an access terminal authenticating unit configured to authenticate a terminal that accesses the sub-document based on the access information; and
an input information based selecting unit configured to select the sub-document based on input information of the authenticated terminal.

6. The apparatus of claim 1, wherein the online document updating unit includes:
an editor driving unit configured to drive an editor that edits a sub-document;
an editing completion determining unit configured to determine whether edition is completed by sensing input of a user or analyzing an input of the user;
a sub-document storing unit configured to store the sub-document that is completely edited when it is determined that the edition is completed; and
an updated document creating unit configured to create the updated online document when it is determined that all edited sub-document are completely edited.

7. The apparatus of claim 6, wherein when the determination is performed based on sensing, if there is no input during a predetermined period of time, the editing completion determining unit determines that the edition is completed, and when the determination is performed based on the analysis of the user's input, if the input indicates completion of editing, the editing completion determining unit determines that the edition is completed.

8. The apparatus of claim 1, wherein the access authority setting unit sets different access authorities for the individual fields or sets different access authorities for the users who access the same field.

9. The apparatus of claim 1, wherein the online document updating unit includes:
a plural editing determining unit configured to determine whether the same sub-document is edited by at least two users; and
a priority based document selecting unit configured to select a sub-document edited by a specific user based on the priority if it is determined that the sub-document is edited by at least two users.

10. The apparatus of claim 1, wherein the online document updating apparatus is used to control a satellite by collectively editing the online document related to a satellite operation.

11. The apparatus of claim 2, wherein the sub-document creating unit creates the sub-document in response to the request of the second user that receives the access authority.

12. An online document updating apparatus, comprising:
a sub-document creating unit configured to create a sub-document including at least one field based on fields included in an online document;
an access authority setting unit configured to set an access authority for the sub-document;
a sub-document selecting unit configured to select a sub-document related to an accessing user among the created sub-documents; and
an online document updating unit configured to combine all sub-document including an edited sub-document to create an updated online document when the selected sub-document is edited.

13. An online document updating method, comprising:
an access authority setting step of setting an access authority for fields included in an online document;
a sub-document creating step of creating a sub-document including at least one field based on the access authority;
a sub-document selecting step of selecting a sub-document related to an accessing user among the created sub-documents; and
an online document updating step of combining all sub-document including an edited sub-document to create an updated online document when the selected sub-document is edited.

14. The method of claim 13, further comprising:
an access authority transferring step of transferring the access authority from a first user to a second user.

15. The method of claim 14, wherein the access authority transferring step includes:
a user information receiving step of receiving user information on the second user from the first user;
a transferring target eligibility determining step of determining whether the second user is eligible as a transferee based on the user information; and
an access authority transfer processing step of transferring the access authority to the second user if it is determined that the second user is eligible and notify the first user or the second user that the second user is not eligible if it is determined that the second user is not eligible.

16. The method of claim 13, wherein the sub-document creating step includes:
an online document dividing step of dividing the online document in the unit of field; and
a field processing step of creating a sub-document for every field based on the access authority or combining fields selected by users to create a sub-document.

17. The method of claim 13, wherein the sub-document selecting step includes:
an access information creating step of creating access information on the selected sub-document;
an access information distributing step of distributing the access information based on a predetermined distribution standard;
an access terminal authenticating step of authenticating a terminal that accesses the sub-document based on the access information; and
an input information based selecting step of selecting the sub-document based on input information of the authenticated terminal.

18. The method of claim 13, wherein the online document updating step includes:
an editor driving step of driving an editor that edits a sub-document;
an editing completion determining step of determining whether edition is completed by sensing input of a user or analyzing an input of the user;
a sub-document storing step of storing the sub-document that is completely edited when it is determined that the edition is completed; and
an updated document creating step of creating the updated online document when it is determined that all edited sub-document are completely edited.
